(19) United States
(12) Patent Application Publication
(10) Pub. No.: US 2024/0092282 A1
(43) Pub. Date: Mar. 21, 2024

(54) HEADLINER FOR VEHICLES WITH SPEAKER

(71) Applicant: DAEHAN SOLUTION CO., LTD, Incheon (KR)

(72) Inventors: Choong HO KWON, Seoul (KR); Daehee PARK, Incheon (KR)

(73) Assignee: DAEHAN SOLUTION CO., LTD, Incheon (KR)

(21) Appl. No.: 18/238,660

(22) Filed: Aug. 28, 2023

(30) Foreign Application Priority Data
Sep. 21, 2022 (KR) 10-2022-0119001

(51) Int. Cl. B60R 13/02

(52) U.S. Cl. CPC B60R 13/0212

(57) ABSTRACT

The present invention provides a headliner for vehicles with a speaker, the headliner including a base material facing a roof panel and a fabric layer installed on a surface of the base material exposed to a vehicle interior, wherein the headliner does not have to use a separate component for sound processing, such as a speaker grill, on the fabric layer by configuring the headline to allow sound generated by a speaker installed on the base material to pass through through-holes formed in the base material and directly pass through the fabric layer, thereby enhancing the aesthetic appearance and beauty of the vehicle interior and making it easy and convenient to use a speaker. In particular, the present invention provides a headliner for vehicles with a speaker, allowing sound generated by the speaker to easily pass through a fabric layer and spread to a vehicle interior by using a breathable fabric for a fabric layer through which the sound passes, thereby further enhancing the sound effect.

### CROSS-REFERENCE TO RELATED APPLICATION

This application claims priority to and the benefit of Korean Patent Application No. 10-2022-0119001, filed on Sep. 21, 2022, the disclosure of which is incorporated herein by reference in its entirety.

### BACKGROUND

### 1. Field of the Invention

The present invention relates to a headliner for vehicles with a speaker, and more particularly, to a headliner for vehicles with a speaker, allowing sound flowing from the speaker to pass through several through-holes and a fabric layer in turn by forming the through-holes in a base material layer on which the speaker is mounted when the speaker is mounted on the headliner including a base material and the fabric layer, so that a speaker mounting position is invisible in a vehicle interior, thereby improving the aesthetic appearance and beauty of the vehicle interior. In this case, a breathable fabric may be used for the fabric layer so that the sound transmission effect is enhanced.

### 2. Discussion of Related Art

In general, a headliner for vehicles is one of large finishing materials that is installed to face a roof panel in a vehicle interior to remove noise flowing into the vehicle interior from the above of a vehicle, so that not only a pleasant indoor environment is created, but also the aesthetic appearance and beauty of the vehicle interior is enhanced. As disclosed in Korean Patent Registration No. 10-2020315 (registered on Sep. 4, 2019), Korean Patent Publication No. 10-2019-0134126 (published on Dec. 4, 2019), and Korean Patent Registration No. 10-0588757 (registered on Jun. 3, 2006) below, in such a headliner, wiring is installed to reinforce the self-stiffness of the headliner hanging from the roof panel or to supply electric power to interior lights or an overhead console (OHC) on the surface facing the roof panel.

In Korean Patent Registration No. 10-2020315, since elastic protrusions protruding from both sides are formed with wiring placed therebetween and elastic rings are hung on the elastic protrusions to surround and fix the wiring, the elastic protrusions and the elastic rings surround and fix the outer edge of the wiring, so installation force can be increased, and also, since the elastic rings are easily mounted on or separated from the elastic protrusions, the wiring can be easily and conveniently mounted or separated. In particular, since O-rings are used for the elastic rings, the elastic rings are easy to obtain in the surroundings and also, are easily hung between the elastic protrusions using elastic force to fix or separate the wiring. Moreover, since at least two support protrusions are formed to protrude from a base, the support protrusions more tightly fix the wiring by supporting and fixing the wiring while pressing the wiring in an uneven shape.

In Korean Patent Publication No. 10-2019-0134126, an objective is to provide a structure for mounting wiring onto a headliner for vehicles, in which a storage space receiving the wiring is formed in a heart shape when a mounting hole is formed in the headliner, such that the wiring is caught on an inlet portion of the mounting hole with a wide wiring insertion width to be prevented from easily falling out, and thus the wiring is stably fixed without additional work and manufacturing cost is reduced thereby. Another objective is to provide a structure for mounting wiring onto the headliner for vehicles, in which the mounting hole is formed in an L-shape and an inlet portion is elastically deformed, such that the inserted wiring is forcibly inserted into and fixed to the mounting hole, and thus the wiring is caught by an edge portion of the headliner, thereby preventing the wiring from easily falling out from the mounting hole.

Korean Patent Registration No. 10-0588757 discloses a polyester staple fiber base of a headliner for vehicles and a method of manufacturing the same, wherein the polyester staple fiber base includes a top layer, an inner layer, and a bottom layer which are made of a mixture fiber of low melting fiber (LMF) and regular fiber as a main component, and each of the top layer and the bottom layer includes low melting fiber 60 to 80 wt % and regular fiber 20 to 40 wt %, the inner layer includes low melting fiber 20 to 40 w % and regular fiber 60 to 80 wt %, and at least one of the top layer and the bottom layer is coated with resin. By coating at least one of the top layer and the bottom layer of polyester (PET) felt with resin to improve the strength of polyester (PET) felt, the polyester staple fiber base has excellent strength and formability, so there is no bending or warping of formed products, and thus there are effects of excellent recycling of materials as well as minimizing of defects. In addition, by configuring polyester (PET) felt to include the top layer, the inner layer, and the bottom layer using the regular fiber and low melting fiber, and coating at least one of the top layer and the bottom layer with resin, the polyester staple fiber base has an excellent sound absorbing and screening performance, and accordingly, has high ability to absorb indoor noise and intercept outdoor noise and has good thermal conductivity, and thus, does not require an additional pad, and therefore, there are effects of simplifying a work process and increasing the efficiency of indoor air conditioner operation.

Meanwhile, as shown in FIGS. 1 to 3, in a headliner H in the related art configured as described above, a speaker S may be mounted and used. In FIG. 2, circles and rectangles drawn by dotted lines indicate mounting positions of the speakers S. The mounting positions of the speakers vary depending on a vehicle model.

In this case, the headliner H includes a base material B facing a roof panel and a fabric layer F mounted on a surface of the base material B exposed to the vehicle interior, as shown in FIG. 3. In addition, a mounting hole P is formed on the base material B, and a through-hole is formed at a position facing the mounting hole P in the fabric layer F, and a speaker grill G is mounted. In this case, the speaker S is mounted on a surface of the base material B facing the roof panel so that the sound passes through the speaker grill G through the mounting hole P.

### SUMMARY OF THE INVENTION

However, as a speaker is mounted on a headliner in the method in the related art, the following problems occur.
(1) As the speaker is installed on the surface of the headliner facing a roof panel, the configuration should be such that sound generated by the speaker is able to pass through the headliner. Accordingly, the speaker grill is mounted on a fabric part constituting the headliner.
(2) As the speaker grill is mounted on the fabric part, the speaker grill is exposed to the vehicle interior when the headliner is viewed from the vehicle interior.
(3) The speaker grill exposed to the vehicle interior in this way not only spoils the aesthetic appearance and beauty of the vehicle interior, but also gives the inconvenience of having to consider the overall aesthetic appearance and beauty should be considered especially when the headliner is manufactured.
(4) In particular, since it is necessary to consider not only the design of the speaker grille exposed to the vehicle interior, but also the mounting position and finishing at the mounting position, it becomes more difficult to manufacture the headliner.
(5) In addition, in a speaker assembly process, even when a separately manufactured speaker grill is mounted and disassembled, the speaker grill should be disassembled as a separate process, which reduces work efficiency.

The present invention has been made in consideration of the above-mentioned problems, and is directed to providing a headliner for vehicles with a speaker, the headliner including a base material facing a roof panel and a fabric layer installed on a surface of the base material exposed to a vehicle interior, wherein the headliner does not have to use a separate component for sound processing, such as a speaker grill, on the fabric layer by configuring the headliner to allow sound generated by a speaker installed on the base material to pass through through-holes formed in the base material and directly pass through the fabric layer, thereby enhancing the aesthetic appearance and beauty of the vehicle interior and making it easy and convenient to use the speaker.

In particular, the present invention is also directed to providing a headliner for vehicles with a speaker, allowing sound generated by the speaker to easily pass through a fabric layer and spread to a vehicle interior by using a breathable fabric for the fabric layer through which the sound passes, thereby further enhancing the sound effect.

Further, the present invention is also directed to providing a headliner for vehicles with a speaker, capable of minimizing sound loss while sound generated by the speaker passes through a base material facing the speaker by forming several through-holes in the base material, and enhancing the sound effect without weakening structural rigidity of the base material by forming the plurality of through-holes.

According to an aspect of the present invention, there is provided a headliner for vehicles with a speaker (S), the headliner including a base material (100) and a fabric layer (200) wrapping a surface of the base material (100) exposed to a vehicle interior, in which a mounting bracket (M) is installed on a surface that is not exposed to the vehicle interior to be used in vehicles, several through-holes (110) are formed on a surface of the base material (100) in contact with the mounting bracket (M), and the mounting bracket (M) is installed on the base material (100) to wrap the through-holes (110) so that sound generated by the speaker (S) passes through the through-holes (110) and directly passes through the fabric layer (200).

In particular, the fabric layer (200) may be a breathable fabric.

In addition, the several through-holes (110) may be formed in a small-diameter hole shape or in a long slit shape, on a surface of the base material (100) facing a diaphragm in the speaker (S).

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view of a vehicle showing a position where a headliner in the related art is mounted on the vehicle;

FIGS. 2A and 2B are a perspective view and a plan view of the headliner, showing a mounting position of a speaker used in a vehicle in the headliner in the related art, respectively;

FIG. 3 is an image of an exploded perspective view for showing a mounting state of a speaker in the headliner in the related art formed by including a base material and a fabric layer wrapping one surface of the base material; and

FIG. 4 is an image of an exploded perspective view for showing a mounting state of a speaker to a headliner with a speaker according to the present invention formed by including a base material and a fabric layer wrapping one surface of the base material according to the present invention.

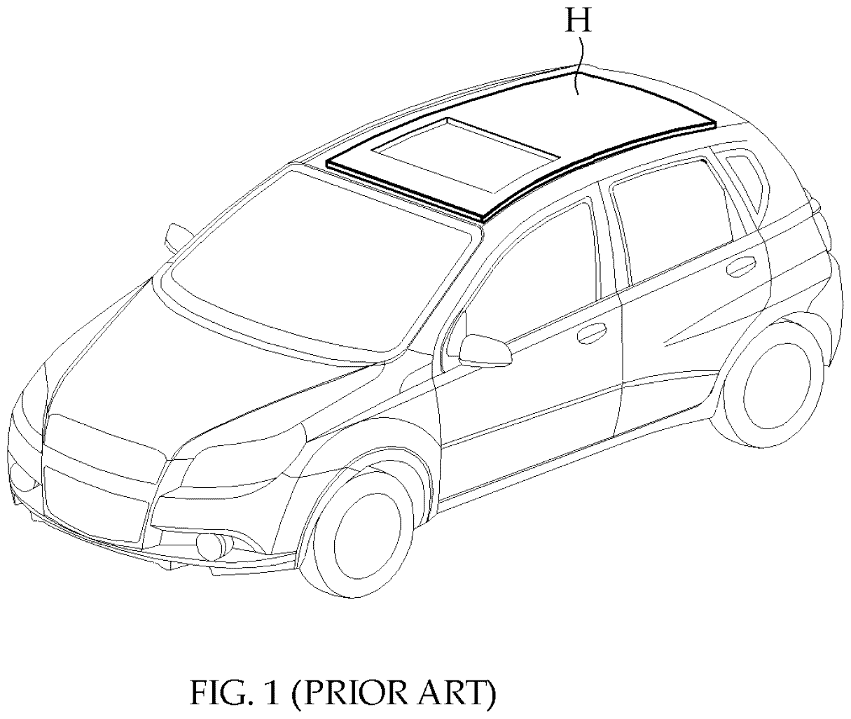

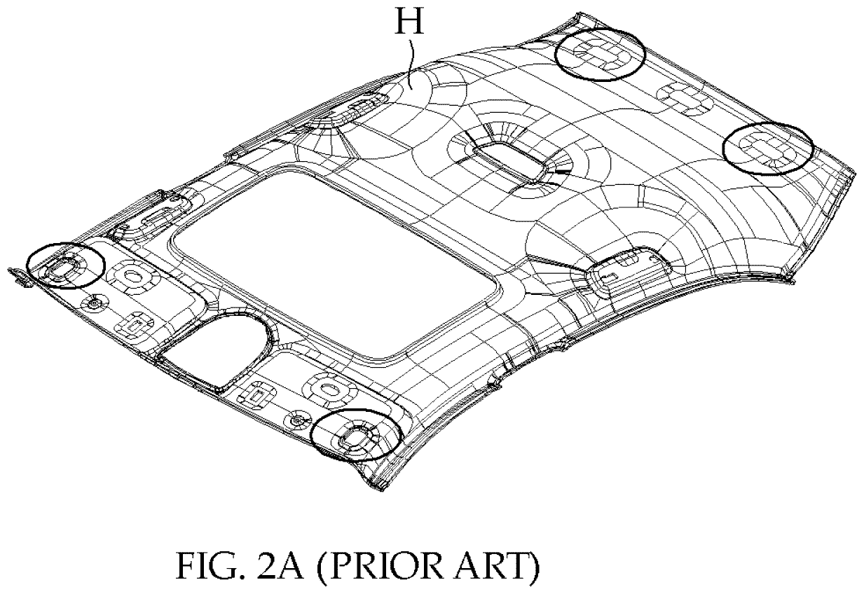

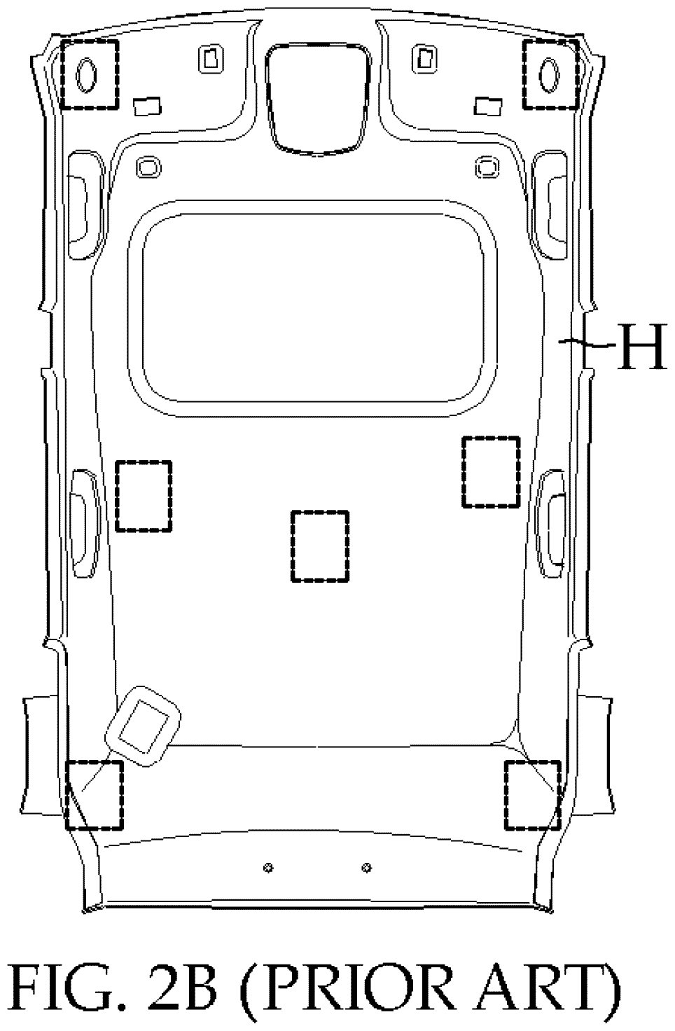

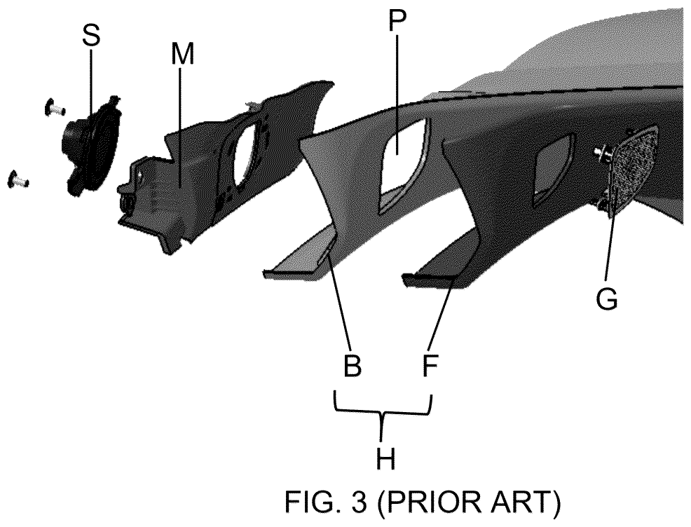

### DETAILED DESCRIPTION OF EXEMPLARY EMBODIMENTS

Hereinafter, preferred embodiments of the present invention will be described in more detail with reference to the accompanying drawings. Prior to the description, terms or words used in this specification and claims should not be restrictively interpreted as ordinary meanings or dictionary-based meanings, but should be interpreted as meanings and concepts conforming to the technical aspects of the present invention according to the principle that an inventor is allowed to properly define concepts of terms to describe his or her invention in the best ways.

Therefore, embodiments described in the specification and configurations shown in the drawings are merely the most preferred embodiment of the present invention, but are not intended to fully describe the technical aspects of the present invention, so it should be understood that a variety of other equivalents and modifications could be made thereto at the time of filing the application.

[Configuration of Headliner for Vehicles with Speaker]

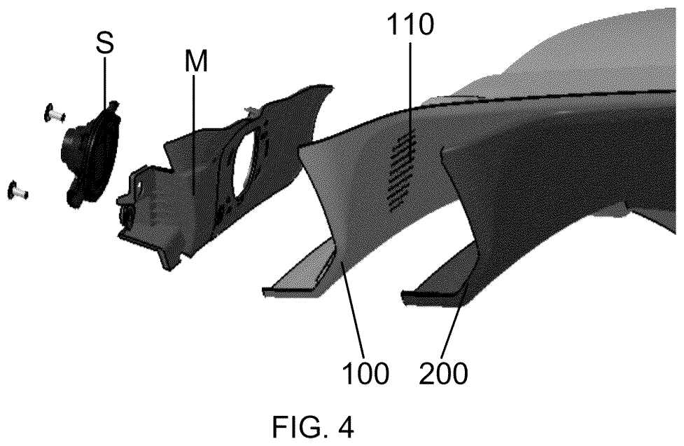

As shown in FIG. 4, a headliner for vehicles with a speaker according to the present invention includes a base material 100 and a fabric layer 200 wrapping a surface of the base material 100 exposed to a vehicle interior. In addition, a mounting bracket M is installed on a surface of the base material 100 that is not exposed to the interior, and a speaker S used in a vehicle is mounted.

In this case, several through-holes 110 are formed in the base material 100 so that sound generated by the speaker S passes therethrough, and the fabric layer 200 is configured such that the sound passing through the through-hole 110 directly passes therethrough, so that when the headliner is viewed from the vehicle interior, a mounting position of the speaker S is invisible, and thus it is possible to improve the aesthetic appearance and beauty of the vehicle interior.

In addition, the through-holes 110 are formed in a slit shape, thereby allowing the sound generated by the speaker S to stably pass through and flow into the vehicle interior while preventing the rigidity of the base material 100 from being weakened.

Further, by using a breathable fabric for the fabric layer 200, through the fabric layer 200 manufactured to allow air to pass therethrough, the sound generated by the speaker S stably passes into the vehicle interior, and thus the sound effect can be further enhanced.

Hereinafter, such a configuration will be described in more detail with reference to the accompanying drawings.

A. Configuration of Headliner

As shown in FIG. 4, the headliner includes the base material 100 configured on a surface facing a roof panel, and the fabric layer 200 installed to wrap the surface of the base material 100 exposed to the vehicle interior.

In addition, as shown in FIG. 4, the mounting bracket M is mounted on the surface of the base material 100 facing the roof panel, and the speaker S mounted in the vehicle interior is installed on the mounting bracket M.

B. Base Material

As shown in FIG. 4, the base material 100 is manufactured to maintain the overall shape of the headliner and improve the noise performance in the vehicle interior.

Accordingly, the base material 100 is made of a material having the sound absorbing and screening performance to improve the noise performance. In this case, the base material 100 is manufactured in various layer structures according to the noise performance required according to the type of vehicle, for example, made of a material having only the sound absorbing performance, such as polyurethane foam, or made of a material having the sound absorbing performance and a material having the sound screening performance in a multi-layered structure.

Meanwhile, in a preferred embodiment of the present invention, several through-holes 110 are formed in the base material 100 as shown in FIG. 4. In this case, the through-holes 110 allow the sound generated by the speaker S mounted on the mounting bracket M installed on the surface of the base material 100 facing the roof panel to directly pass through the base material 100 and be transmitted to the vehicle interior, thereby enhancing the sound effect.

In this case, in a preferred embodiment of the present invention, it is preferable to form several through-holes 110 so that the sound generated by the speaker may directly pass through the base material 100 through a region where the sound is generated in the speaker S, that is, through a driver unit of the speaker.

In particular, in a preferred embodiment of the present invention, the through-holes 110 are manufactured according to the same or similar size as a shape of the driver unit, and in this case, when the number of through-holes 110 is too large or the size of the through-holes 1100 is too large, there is a risk of weakening the structural rigidity of the base material 100. Accordingly, as shown in FIG. 4, several through-holes 110 having a small diameter are preferably formed at regular intervals on a surface facing the driver unit.

In addition, the through-holes 110 may reinforce the rigidity of the base material 100 as the through-holes 110 are finely formed, but may act as a resistance when sound passes through. Accordingly, it is most preferable to form several through-holes 110 in a narrow and long slit or grill shape on the surface of the base material 100 in contact with the driver unit.

As shown in FIG. 4, the fabric layer 200 is installed on the surface of the base material 100 exposed to the vehicle interior as described above.

C. Fabric Layer

As shown in FIG. 4, the fabric layer 200 is mounted on one surface of the above-described base material 100, preferably the surface of the base material 100 exposed to the vehicle interior, which is a surface on which the mounting bracket M for supporting the speaker S is not installed.

In this case, as shown in FIG. 4, it is preferable that the fabric layer 200 is formed to wrap a portion where the through-holes 110 described above are formed as it is, so that the sound generated by the speaker S passes through the through-hole 110, and then directly passes through the fabric layer 200 and spreads to the vehicle interior.

Accordingly, by using a breathable fabric produced to allow air to pass therethrough for the fabric layer 200, the effect of transmitting sound generated by the speaker may be enhanced, and the mounting position of the speaker S may not be exposed in the vehicle interior, thereby enhancing the aesthetic appearance and beauty.

As described above, according to the present invention, by forming through-holes only in the base material in the headliner including the base material and the fabric layer wrapping the base material, and configuring the fabric layer to wrap the entire base material including the through-holes, it is possible to obtain the sound effect of the speaker without exposing the speaker to the vehicle interior.

Accordingly, the present invention may improve the aesthetic appearance and beauty of the vehicle interior because the mounting position of the speaker is not exposed to the outside in the headliner, which is a finishing material installed over a large area in the vehicle interior.

In addition, the present invention may obtain the sound effect by using a breathable fabric for the fabric layer so that the sound generated by the speaker easily passes through the fabric layer and spreads in the vehicle interior as air passes through.

A headliner for vehicles with a speaker according to the present invention has the following effects.
(1) By configuring the headliner to allow sound generated by a speaker to directly passes through a fabric layer exposed to a vehicle interior from a base material, it is possible to eliminate a speaker grill installed on a fabric layer of an existing headliner.
(2) As described above, in the present invention, since the speaker grill is not mounted on the headliner, not only the aesthetic appearance and beauty of the headliner can be improved, but also a finishing effect of the vehicle interior can be improved.
(3) In addition, since it is not necessary to manufacture the speaker grill, not only can the manufacturing costs be reduced that much, but also a process of mounting the speaker grill can be eliminated, and thus work efficiency can be improved during assembly and disassembly work.
(4) Further, when the headliner is manufactured, it is not necessary to process holes for mounting the speaker grill on the fabric layer, and thus the number of work steps can be reduced.
(5) Meanwhile, by using a breathable fabric layer for the fabric layer, the air is well ventilated, so that the sound transmission effect generated by the speaker can be further enhanced, and as a result, the sound effect can be enhanced.

1. A headliner for vehicles with a speaker (S), the headliner comprising:
a base material (100); and
a fabric layer (200) wrapping a surface of the base material (100) exposed to a vehicle interior,
wherein a mounting bracket (M) is installed on a surface that is not exposed to the vehicle interior to be used in vehicles,
several through-holes (110) are formed on a surface of the base material (100) in contact with the mounting bracket (M), and
the mounting bracket (M) is installed on the base material (100) to wrap the through-holes (110) so that sound generated by the speaker (S) passes through the through-holes (110) and directly passes through the fabric layer (200).

2. The headliner of claim 1, wherein the fabric layer (200) is a breathable fabric.

3. The headliner of claim 1, wherein the several through-holes (110) are formed in a small-diameter hole shape or in a long slit shape, on a surface of the base material (100) facing a diaphragm in the speaker (S).

4. The headliner of claim 2, wherein the several through-holes (110) are formed in a small-diameter hole shape or in a long slit shape, on a surface of the base material (100) facing a diaphragm in the speaker (S).
